(19) United States
(12) Patent Application Publication
(10) Pub. No.: US 2025/0225459 A1
(43) Pub. Date: Jul. 10, 2025

(54) OPERATION ASSISTANCE SYSTEM FOR A USER OF A CONTAINER TREATMENT PLANT

(71) Applicant: Krones AG, Neutraubling (DE)

(72) Inventors: Heinz Hennek, Neutraubling (DE); Thomas Albrecht, Beilngries (DE)

(21) Appl. No.: 19/002,434

(22) Filed: Dec. 26, 2024

(30) Foreign Application Priority Data
Jan. 4, 2024 (DE) 102024100207.7

(51) Int. Cl. G06Q 10/0631; B67C 3/00

(52) U.S. Cl. CPC G06Q 10/06316; B67C 3/007

(57) ABSTRACT

The present invention comprises an operation assistance system for a user of a container treatment plant, in particular a bottle filling plant. The operation assistance system comprises a position detecting apparatus that detects a position and orientation of the user in the container treatment plant, wherein the position detecting apparatus, on the basis of the position and orientation of the user, recognizes a treatment apparatus in the container treatment plant that is operated by the user, an operation detecting apparatus that detects the operating state of the recognized treatment apparatus, and a mobile operation assistance apparatus that assists the user when operating the treatment apparatus by operating recommendations on the basis of the operating state of the recognized treatment apparatus.

### CROSS-REFERENCE TO RELATED APPLICATION(S) AND CLAIM OF PRIORITY

This application claims priority to German Patent Application No. 102024100207.7, filed Jan. 4, 2024, the disclosure of which is incorporated herein by reference in its entirety.

### TECHNICAL FIELD

The present invention relates to an operation assistance system for a user of a container treatment plant, in particular a bottle filling plant.

### BACKGROUND

Container treatment plants comprising, for example, filling apparatuses or blowing apparatuses for plastics material containers, inspection apparatuses, transport apparatuses, packaging apparatuses, marking apparatuses, or labeling apparatuses, are known from the prior art.

During operation of a container treatment plant, operating procedures, retrofitting work, supply steps, troubleshooting steps or similar are necessary during the course of the application. Container treatment plants are usually very large plants which cannot be fully overseen and understood by a user right at the very beginning of an operational procedure. Due to the changing structure and complexity of the plants, the sequence of operations of the plant is usually unknown to the user and difficult to understand. The fulfillment of tasks by a user depends heavily on their capability and know-how. As a consequence, the efficiency of the container treatment plant also depends on the capability of the individual user working in the plant.

EP 2901225 discloses an operating system for a plant, in particular for a beverage processing machine. The operating system comprises a mobile operating apparatus for the plant, a signal generator for issuing alarm and/or warning signals, and glasses comprising a display system which is configured in particular as a head-mounted display or virtual retinal display or projector, and wherein the operating apparatus and/or the signal generator and/or the safety glasses each comprise a data transmitter for exchanging machine information and/or alarm and/or warning signals. A user of the operating system receives virtual operating apparatuses of the plant displayed on the display system and can change parameters of the plant particularly easily using gestures or the operating apparatus. The operating system can use the display system to indicate supply delays, plant malfunctions or the like and draw the user's attention thereto.

WO 2016207948 provides a guidance system for a user, on the basis of which the user can be guided from a currently located position to a process apparatus in a plant at which a work step is to be carried out. A display apparatus shows the user their current position and a path that the user can take within a work area. The user is thus guided as quickly as possible to a process apparatus at which a work step is to be carried out. This increases the efficiency of the plant by coordinating the movement of a user in a plant.

However, the user's ability to complete tasks continues to depend heavily on their level of training and ability to absorb information. A user who has never or rarely used an apparatus in the plant to which said user is guided will not know how to operate it. The apparatus parameters are displayed to the user, but the user requires preparation or instruction for them to operate the apparatus for suitable operation. This can lead to time being lost until the user has understood which work step needs to be carried out and how to optimally adjust the plant. On the other hand, incorrect operation can lead to operational pauses or shutdown of the plant's operating process. This causes delays in the process sequences of the container treatment plant and thus leads to a reduction in the container treatment plant's productivity.

### SUMMARY

The object of the present invention is therefore that of providing an operation assistance system which makes it possible to simplify the operation of apparatuses in a container treatment plant by assisting the user. In addition, the operating reliability of such plants is intended to be increased. According to the invention, this object is achieved by the subject matter of this disclosure. A method for solving the above-mentioned problems is solved by the display method of this disclosure. Advantageous embodiments and developments are also provided by this disclosure.

An operation assistance system according to the invention for a user of a container treatment plant, in particular a bottle filling plant, comprises: a position detecting apparatus that detects a position and orientation of the user in the container treatment plant, wherein the position detecting apparatus, on the basis of the position and orientation of the user, recognizes a treatment apparatus in the container treatment plant that is operated by the user; an operation detecting apparatus that detects the operating state of the recognized treatment apparatus; and a mobile operation assistance apparatus that assists the user when operating the treatment apparatus by operating recommendations on the basis of the operating state of the recognized treatment apparatus.

This results in the advantage that the operation assistance system according to the invention assists the user by active operating instructions to operate the container treatment plant properly and purposefully. The operator is not only guided to the location of a problem, but is actively assisted when implementing the solution to the problem. This results in faster and easier operation of the plant, appropriate response to errors, purposeful retrofitting, and timely supply of the apparatuses within the container treatment plant, regardless of the user's level of training and knowledge. This leads to an increase in the efficiency and productivity of the container treatment plant. The mobility of the operation assistance apparatus ensures easy handling of the system and the possibility of retrofitting existing container treatment plants.

Advantageous developments of the invention are also provided in this disclosure.

It may be advantageous if the position detecting apparatus, the operation detecting apparatus and the mobile operation assistance apparatus are combined in one apparatus, preferably in glasses which show information in the user's field of view, even more preferably augmented reality glasses. Combining the features in one apparatus helps with rendering the system compact and thus wear comfort for the user, who can then move around the plant more quickly. Such a combination in one apparatus also makes it easier to retrofit an existing container treatment plant, since only the glasses and their connection to a control station are required. The use of glasses or augmented reality glasses allows the plant and the settings and parameters of an apparatus to be operated to be simultaneously viewed. The use of augmented reality glasses also arouses curiosity and increases the user's motivation to deliver reliable work. At the same time, the mobile operation assistance apparatus in the form of glasses can avoid the space required for extensive displays within the container treatment plant.

It may prove useful if the operation assistance system further comprises at least one data transmitter for exchanging state information between the position detecting apparatus, the operation detecting apparatus, the mobile operation assistance apparatus, and a control station of the container treatment plant, wherein the control station is preferably an external server or a cloud. This allows for wireless exchange between the apparatuses and state information to be exchanged in real time. At the same time, externally processing data can avoid the space required for extensive server plants within the container treatment plant. Such a structure of the operation assistance system also makes it easier to retrofit an existing container treatment plant, since only the glasses and their connection to the control station are required.

It can be helpful if the operation assistance system further comprises a state simulation apparatus which, taking into account the environmental boundary conditions, simulates a digital image of the operating state of each treatment apparatus of the container treatment plant, preferably while in operation, simulates operating scenarios and, based on their results, transmits operating recommendations to the mobile operation assistance apparatus using a data transmitter. This has the advantage that a digital twin of the plant can be used to virtually simulate operating scenarios in such a way that parameter recommendations can be calculated in real time, resulting in improved operation of the plant. The state simulation apparatus simulates best-case scenarios and runs through optimization loops and thus has low-effort access to operating states of the plant, on the basis of which decisions about the operating state can be made, for example using an AI-controlled strategy.

It may prove advantageous if the operating recommendations are displayed by the mobile operation assistance apparatus and are at least one, two or more of the following: parameter setting specifications for manipulated variables of the treatment apparatus, virtually displaying the treatment apparatus being operated, preferably operated by a tool, measures for correcting errors in the treatment apparatus or proposals for optimizing the arrangement of the treatment apparatus in the container treatment plant. This can ensure that the apparatuses in the plant are suitably adjusted, the plant can be repaired quickly, errors can be corrected quickly, and the plant is arranged in a way that is suitable for the application. Overall, this increases the availability and efficiency of the plant.

It may be useful if the operation assistance system further comprises a display apparatus which displays a direction of a shortest path to a further treatment apparatus, preferably by an arrow on the ground, more preferably projected onto the ground by the mobile operation assistance apparatus, wherein the further treatment apparatus is a treatment apparatus on which an operating recommendation is to be carried out. If a parameter change, error correction or a supply step is to be carried out on a second treatment apparatus, this ensures marked walking routes for users and thus ensures fast achievement and timely implementation of the operating steps of the second treatment apparatus.

It may be practical if the mobile operation assistance apparatus comprises a hearing/speaking unit which comprises speech recognition and is in particular connected to the data transmitter of the operation assistance apparatus for exchanging speech information. This enables rapid information exchange and time optimization of the operation of the plant since a selection of at least one operating recommendation is recognized and returned to the container treatment plant. It can also be practical if the mobile operation assistance apparatus comprises ear protection for suppressing disturbing ambient noise, which protection in particular works using active noise cancellation. Such a device encourages the user to concentrate on carrying out work steps on the plant. It may also be practical if the mobile operation assistance apparatus comprises a camera for capturing objects in the user's field of vision and for recording states occurring in the user's field of vision. This means that the user's work area can be recorded for learning and training purposes, for example, and an instructor or specialist can follow the user's view in order to recognize malfunctions and be able to provide further operating instructions. It may also be practical if the mobile operation assistance apparatus comprises a second camera which is configured to capture at least one of the user's eyes in order to identify the user and/or is configured to recognize a viewing direction of the user. This means that a profile can be assigned to the user depending on their level of knowledge and the user's level of knowledge can be incorporated into the operation assistance. Such a profile can be used to query the user's authorization level, which influences the user interface or prevent the user from performing certain work tasks with a higher level of security. In addition, such a second camera can be used to control and select recommendations concerning the user's gaze. This enables rapid information exchange and time optimization of the operation of the plant since a selection of at least one operating recommendation is recognized and returned to the container treatment plant. It may also be practical if the mobile operation assistance apparatus comprises a gesture recognition unit for recognizing the user's gestures. This allows for quick selection of the operating recommendations and a time optimization of the operation of the plant since a selection of at least one operating recommendation is recognized and returned to the container treatment plant. It may also be practical if the mobile operation assistance apparatus displays two different images to the user in order to show an actual state and a recommended state of the treatment apparatus. This allows the user to see a variety of information necessary for the operating procedure at a glance in order to carry out a work step quickly and purposefully.

It may prove useful if the position detecting apparatus records and stores the user's paths and the state information and boundary conditions of the operating environment, and the operation detecting apparatus records and stores the environmental boundary conditions and the operating state of the treatment apparatus arranged in the user's path. This serves to document the execution of work steps and to assist with data analysis to feed the simulations and revise the plant's operating processes. Conclusions can also be drawn about the efficiency of a user and the treatment apparatuses.

The invention further comprises a container treatment plant, in particular a bottle filling plant, which comprises at least one treatment apparatus that treats a container (B) and an operation assistance system according to any one of the preceding aspects.

An operating method according to the invention for assisting a user of a container treatment plant, in particular a bottle filling plant, comprises detecting a position and orientation of the user in the container treatment plant, wherein, on the basis of the position and orientation of the user, a treatment apparatus in the container treatment plant that is operated by the user is recognized, detecting an operating state of the recognized treatment apparatus and assisting the user when operating the recognized treatment apparatus by operating recommendations on the basis of the operating state of the recognized treatment apparatus.

Further preferred developments of the invention can be found in combinations of the features disclosed in the description, the claims, and the drawings.

### BRIEF DESCRIPTION OF THE DRAWINGS

For a more complete understanding of this disclosure and its advantages, reference is now made to the following description, taken in conjunction with the accompanying drawings, in which:

FIG. 1 shows a perspective view of a user with the operation assistance system in front of a treatment apparatus of a container treatment plant;

FIG. 2 shows a mobile operation assistance apparatus of the operation assistance system in the form of augmented reality glasses; and

FIG. 3 shows a container treatment plant comprising a plurality of treatment apparatuses.

### DETAILED DESCRIPTION

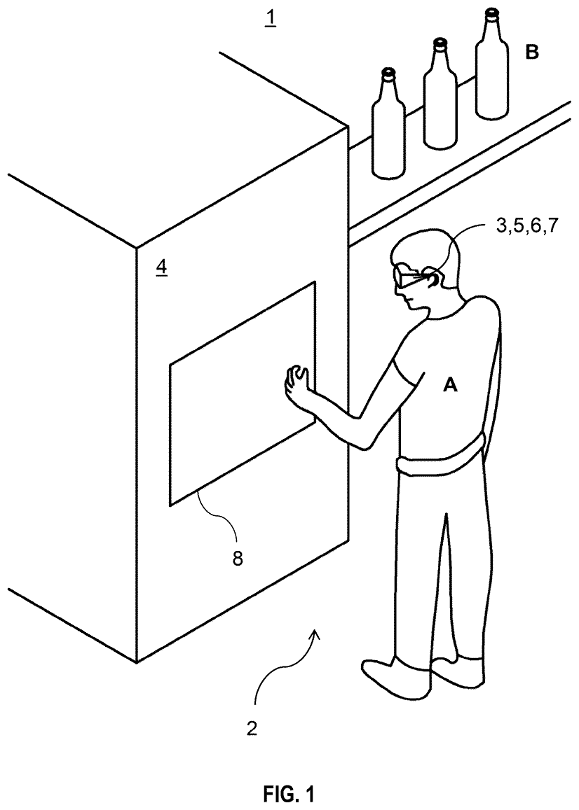

FIG. 1 shows a perspective view of a user A with the operation assistance system 2 in front of a treatment apparatus 4 of a container treatment plant 1. FIG. 1 is a two-dimensional plan view of the container treatment plant 1. The container treatment plant 1 is a processing line of apparatuses for treating containers B, and in particular beverage containers B, using at least one treatment apparatus 4. The processing line can be modular and be composed of transport apparatuses, blow molding apparatuses, filling apparatuses, inspection apparatuses, packaging apparatuses, marking apparatuses, labeling apparatuses, and the like, which carry out processing steps on the containers B. Mobile supply apparatuses can also be added onto the processing line. By retrofitting work, the processing line can be modified as required such that the processing line can process containers B of different sizes and quantities and made of different materials.

The treatment apparatus 4 comprises a display apparatus 8 on which an operating status of the treatment apparatus 4 can be displayed. The display apparatus 8 shows the actual state of the treatment apparatus 4 or indicates a supply state. A potential need for fresh supplies or malfunctions are also indicated on the display apparatus 8. The display apparatus 8 can also be used as a control panel to accept inputs from a user A. In other words, the display apparatus 8 is a touch-sensitive display apparatus, wherein a displayed view can also be moved, rotated, and/or zoomed by touching it.

The user A is equipped with an operation assistance system 2. The operation assistance system 2 comprises a position detecting apparatus 3, an operation detecting apparatus 5 and a mobile operation assistance apparatus 6. The position detecting apparatus 3, the operation detecting apparatus 5 and the mobile operation assistance apparatus 6 are combined in one apparatus. This apparatus is preferably a pair of glasses 7 that show information in the user's field of view. Augmented reality glasses 7 are even more preferred.

The position detecting apparatus 3 detects the actual position and orientation of the user A and transmits this to the operation assistance system 2 so that a treatment apparatus 4 in the container treatment plant 2 in front of which the user A is standing or which the user A is operating can be recognized. The user can be located using GPS or an indoor positioning technology such as ultra-wideband (UWB), radio frequency identification (RFID), Bluetooth or WLAN. The treatment apparatus 4 operated by the user A can also be detected by recognizing QR codes on the treatment apparatus 4, which are recorded by the camera 5 in the operation assistance system 2. It is thus possible for the treatment apparatus 4 to be detected without locating the user. Nevertheless, the position of the user A can be deduced from a plant plan for the container treatment plant 1.

The operation detecting apparatus 5 determines the current operating state of the container treatment plant 4 in front of which the user with the operation assistance system 2 is located. In less complex container treatment plants 4 (only on/off plants), this is done by the camera 5. For the majority of container treatment plants 4, the operation detecting apparatus 5 obtains operating information from a control station 9 of the container treatment plant 1 (not shown). The control station 9 is preferably an external apparatus in the form of a server or a cloud.

The control station 9 is configured to simulate a digital image of the operating state of each treatment apparatus 4 of the container treatment plant 1, taking into account the environmental boundary conditions, preferably at the same time as the container treatment plant is in operation. Furthermore, operating scenarios are simulated on the control station 9 and their results are analyzed. From the simulation results, parameter changes are generated that have the potential to optimize the operation of the treatment apparatuses 4 in the container treatment plant 1. These include, for example, rinsing temperatures for reliable but rapid rinsing of containers B, transfer rates of the containers B to transfer apparatuses to avoid congestion, holding forces of the containers B and the like. From the simulation, operating recommendations are accordingly generated on the basis of the operating state of the treatment apparatus 4 recognized by the operation detecting apparatus 5 in order to optimize operation of the treatment apparatus 4.

The mobile operation assistance apparatus 6 is configured to transfer the operating recommendations for the recognized treatment apparatus 4 to the user A and thus to assist the user A when operating the treatment apparatus 4 by operating recommendations. The operation detecting apparatus 5 is connected to the mobile operation assistance apparatus 6 and additionally displays the operating state of the recognized container treatment plant 4 on the mobile operation assistance apparatus 6.

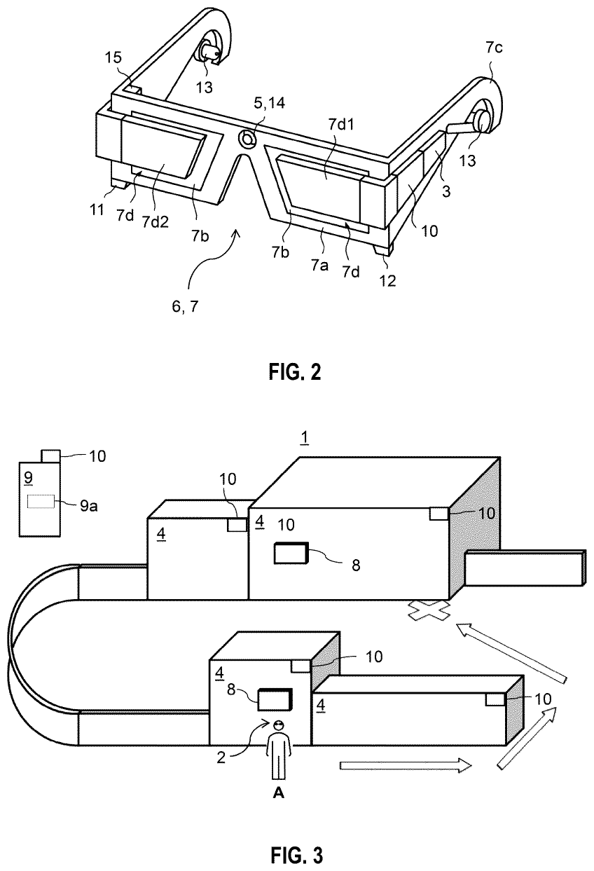

FIG. 2 shows a perspective view of the operation assistance apparatus 6 in the form of glasses 7. The position detecting apparatus 3 and the operation detecting apparatus 5, in the form of a camera 5, can be integrated in the glasses 7. As shown in FIG. 2, the glasses 7 comprise a frame 7a in which the lenses 7b are embedded. Furthermore, the glasses 7 have two temples 7c, which are worn over the ears of the user A. A glasses display apparatus 7d is arranged in front of each lens 7b of the glasses 7. These are each configured as optical glass or as a head-mounted display 7d1, 7d2. The head-mounted displays 7d1, 7d2 have optics that allow the user A to see different images from LCD displays in each eye. The head-mounted displays 7d1, 7d2 are semi-transparent so that the user A can see the environment in front of the safety glasses 7 at the same time. With the display apparatus 7d, different images can be shown to the user A in each eye such that said user can also view three-dimensional information. Consequently, the user A sees, on the one hand, the environment and, on the other hand, virtual information overlaid therewith through the glasses 7. For example, the user A can be shown the set parameters and/or the appropriate tool type for a treatment apparatus in the field of view, similar to a legend in a drawing.

The operation assistance apparatus 6 has a data transmitter 10 which is configured to exchange state information between the position detecting apparatus 3, the operation detecting apparatus 5 and the mobile operation assistance apparatus 6. The data transmitter 50 is configured as a wireless radio interface. The radio interface can be a WLAN or Bluetooth interface. The glasses 7 are connected to the container treatment plant 4 in FIG. 1 via the data transmitter 10. The glasses 7 can also be connected to the control station 9. This connection allows data to be exchanged between the units. The glasses 7 also comprise the first camera 5, which faces forward and captures the field of vision of the user A. In this case, the first camera 5 generates image data of the environment immediately in front of the user A, which can be passed on to colleagues via the data transmitter 10 so that they can assist the user A during servicing. Objects or QR codes in the field of vision of the user A can also be automatically recognized from the image data. Furthermore, a gesture recognition unit 12 detects the hands of the user A in order to record their gestures as sequences. The sequences thus obtained can be transmitted via the data transmitter 10 to the control station 9 in order to analyze the gestures.

In addition, the glasses 7 have a hearing/speaking unit 11, 13. This comprises headphones with integrated ear protection. The headphones 13 are configured as earplugs (in-ear headphones) for each ear so as to seal against the ear canal. This suppresses disturbing ambient noise and prevents it from entering the ear canal. At the same time, a microphone 11 detects the disturbing ambient noise from the outside and additionally emits a compensation signal through the headphones 13 such that the remaining ambient noise is further reduced. In addition, useful signals, such as human voices, are captured by the microphone 11 and filtered out by a filter unit (not shown here) and played to the user A via the headphones 13 in a manner isolated from the ambient noise. This enables the user A to communicate with colleagues on-site. Furthermore, the illustrated hearing/speaking unit 11, 13 can be used as a telephone device in conjunction with a mobile phone or other units of the operation assistance system 2. For example, to talk to colleagues who are not on-site. The hearing/speaking unit 11, 13 can be connected to external units via a data transmitter 10, in particular to transmit voice data.

In addition, the glasses 7 have a second camera 15 which faces one eye of the user A. Image data from the second camera 15 are forwarded to the control station 9 via the data transmitter 10. There they are used to analyze the viewing direction and to identify the user A using biometric recognition features.

In addition, the glasses 7 can comprise the position detecting apparatus 3 in the form of a location sensor 3, with which the position and orientation of the glasses 7 can be determined. The location sensor 3 comprises a plurality of acceleration sensors and position sensors. This makes it possible to determine the orientation and position of the head of the user A in relation to the container treatment plant 4. The glasses 7 have a battery (not shown here) for supplying power and can also comprise their own microprocessor in the form of a control unit.

The control station 9 provides operating recommendations to the user A via the operation assistance apparatus 6 or the glasses 7. The operating recommendations are provided to the user A by voice transmission via the hearing/speaking unit 11, 13 or in image format via the display apparatus 7d. The user A can accept or reject the operating recommendations using voice control, gesture control or gaze control. The operating recommendations are provided to the user A by the mobile operation assistance apparatus 6. The operating recommendations are parameter setting specifications for manipulated variables of the treatment apparatus 4, virtually displaying the treatment apparatus 4 being operated, for example operated using a tool, measures for correcting errors in the treatment apparatus 4 or proposals for optimizing the arrangement of the treatment apparatus 4 in the container treatment plant 1.

FIG. 3 shows a container treatment plant 1 comprising a plurality of treatment apparatuses 4. Each treatment apparatus 4 comprises a display apparatus 8 and a data transmitter 10. The control station 9 having the state simulation apparatus 9a also comprises a data transmitter 10. Each treatment apparatus 4 and the control station 9 also comprise data transmitters 10 such that all apparatuses are networked with one another and with the operation assistance system 2 and can exchange data.

Operating situations may occur in which an operating recommendation must be carried out on at least two container treatment plants 4. Thus, a user A must be guided from a first treatment apparatus 4, on which a first recommended step has been carried out, to another treatment apparatus 4, on which a further recommended step is to be implemented. The shortest path from the first treatment apparatus 4 to the second treatment apparatus 4 is shown in FIG. 3 by arrows that are shown to the user A on the display apparatus 7d of the glasses 7. In this way, a user A can quickly understand which route is to be selected in order to reach another container treatment plant 4 as quickly as possible so as to carry out a work step there. The target treatment apparatus 4 is marked by an X, as in FIG. 3. It is also conceivable that the user A is guided to the target position by speech, audio, and/or light signals.

The present invention is not limited to the embodiments described. Further modifications and variations of the embodiments are conceivable. Thus, it would be possible for the position detecting apparatus 3 to be configured to record and store the paths of the user A and the state information and environmental boundary conditions when operating the container treatment plant 1. The operation detecting apparatus 5 may be configured to record and store the environmental boundary conditions and the operating state of the treatment apparatuses 4 arranged in the path of the user A. This allows for full documentation of the operating procedure for the container treatment plant 1 and the recommended work steps carried out for any revisions and potential raw data for further simulations of the state simulation apparatus 9a.

It is also conceivable that the control station 9 lists a plurality of operating recommendations and prioritizes them according to importance, urgency, or complexity. Each prioritized work step is passed on to the user on the operation assistance system 3. The following work steps can already be announced via the operation assistance system 3. Depending on the movement and position of the user A, work steps can be dynamically assigned to other users A in better positions.

It is also conceivable that the path to a target treatment apparatus 4 comprises intermediate destinations. For example, a user A can be guided past a supply station or workshop in order to be appropriately equipped for the recommended work step.

While the invention has been described in relation to specific embodiments for the purpose of full and clear disclosure, the appended claims are not to be limited in this way, but are to be construed to embody all modifications and alternative structures that fall within the scope of protection of the claims and which may reasonably occur to those skilled in the art. In addition, the features of different implementation embodiments may be combined to form further embodiments of the invention.

### LIST OF REFERENCE SIGNS

1: container treatment plant;
2: operation assistance system;
3: position detecting apparatus;
4: treatment apparatus;
5: operation detecting apparatus;
6: mobile operation assistance apparatus;
7: glasses, augmented reality glasses;
7a: frame;
7b: lens;
7c: temple;
7d: glasses display apparatus;
7d1, 7d2: optical glass, head-mounted display;
8: display apparatus;
9: control station;
9a: state simulation apparatus;
10: data transmitter;
11: hearing/speaking unit;
12: gesture recognition unit;
13: ear protection;
14: first camera
15: second camera
A: user
B: container

What is claimed is:

1. An operation assistance system for a user of a container treatment plant, comprising:
a position detecting apparatus configured to detect a position and an orientation of the user in the container treatment plant, wherein the position detecting apparatus is configured, based on the position and the orientation of the user, to recognize a treatment apparatus in the container treatment plant that is operated by the user;
an operation detecting apparatus configured to detect an operating state of the recognized treatment apparatus; and
a mobile operation assistance apparatus configured to assist the user when operating the treatment apparatus using operating recommendations based on the operating state of the recognized treatment apparatus.

2. The operation assistance system of claim 1, wherein the position detecting apparatus, the operation detecting apparatus, and the mobile operation assistance apparatus are combined in one apparatus.

3. The operation assistance system of claim 2, wherein the one apparatus is augmented reality glasses which show information in a field of view of the user.

4. The operation assistance system of claim 1, further comprising at least one data transmitter configured to exchange state information between the position detecting apparatus, the operation detecting apparatus, the mobile operation assistance apparatus, and a control station of the container treatment plant, wherein the control station is an external server or a cloud system.

5. The operation assistance system of claim 4, further comprising a state simulation apparatus which is configured to simulate a digital image of the operating state of each treatment apparatus of a plurality of treatment apparatuses of the container treatment plant while in operation, based on environmental boundary conditions, to simulate operating scenarios and, based on results thereof, to transmit the operating recommendations to the mobile operation assistance apparatus using the data transmitter.

6. The operation assistance system of claim 5, wherein:
the position detecting apparatus is configured to record and store paths of the user and the state information and the environmental boundary conditions of an operating environment of the operation assistance system; and
the operation detecting apparatus is configured to record and store the environmental boundary conditions and the operating state of the treatment apparatus arranged in a path of the user.

7. The operation assistance system of claim 5, wherein:
the operating recommendations are provided to the user by the mobile operation assistance apparatus and are at least one of:
parameter setting specifications for manipulated variables of the treatment apparatus;
virtually displaying the treatment apparatus being operated, preferably operated by a tool;
measures for correcting errors in the treatment apparatus; or
proposals for optimizing an arrangement of the treatment apparatus in the container treatment plant.

8. The operation assistance system of claim 5, further comprising:
a display apparatus configured to display a direction of a shortest path to a further treatment apparatus by an arrow projected on the ground by the mobile operation assistance apparatus, wherein the further treatment apparatus is a treatment apparatus on which an operating recommendation is to be carried out.

9. The operation assistance system of claim 1, wherein:
the operating recommendations are provided to the user by the mobile operation assistance apparatus and are at least one of:
parameter setting specifications for manipulated variables of the treatment apparatus;
virtually displaying the treatment apparatus being operated, preferably operated by a tool;
measures for correcting errors in the treatment apparatus; or
proposals for optimizing an arrangement of the treatment apparatus in the container treatment plant.

10. The operation assistance system of claim 9, including at least one of:
the mobile operation assistance apparatus comprises a hearing/speaking unit which comprises speech recognition and is connected to a data transmitter of the operation assistance apparatus for exchanging speech information;
the mobile operation assistance apparatus comprises ear protection for suppressing disturbing ambient noise using active noise cancellation;
the mobile operation assistance apparatus comprises a camera for capturing objects in a field of vision of the user and for recording states occurring in the field of view of the user;
the mobile operation assistance apparatus comprises a second camera which is configured to perform at least one of:
a capture at least one eye of the user in order to identify the user; or
a recognition of a viewing direction of the user;
the mobile operation assistance apparatus comprises a gesture recognition unit for recognizing gestures of the user; or
the mobile operation assistance apparatus is configured to display two different images to the user in order to show an actual state and a recommended state of the treatment apparatus.

11. The operation assistance system of claim 1, further comprising:
a display apparatus configured to display a direction of a shortest path to a further treatment apparatus by an arrow projected on the ground by the mobile operation assistance apparatus, wherein the further treatment apparatus is a treatment apparatus on which an operating recommendation is to be carried out.

12. The operation assistance system of claim 11, including at least one of:
the mobile operation assistance apparatus comprises a hearing/speaking unit which comprises speech recognition and is connected to a data transmitter of the operation assistance apparatus for exchanging speech information;
the mobile operation assistance apparatus comprises ear protection for suppressing disturbing ambient noise using active noise cancellation;
the mobile operation assistance apparatus comprises a camera for capturing objects in a field of vision of the user and for recording states occurring in the field of vision of the user;
the mobile operation assistance apparatus comprises a second camera which is configured to perform at least one of:
a capture at least one eye of the user in order to identify the user; or
a recognition of a viewing direction of the user;
the mobile operation assistance apparatus comprises a gesture recognition unit for recognizing gestures of the user; or
the mobile operation assistance apparatus is configured to display two different images to the user in order to show an actual state and a recommended state of the treatment apparatus.

13. The operation assistance system of claim 1, wherein:
the position detecting apparatus is configured to record and store paths of the user and state information and environmental boundary conditions of an operating environment of the treatment apparatus; and
the operation detecting apparatus is configured to record and store the environmental boundary conditions and the operating state of the treatment apparatus arranged in a path of the user.

14. A container treatment plant system of a container treatment plant, comprising:
at least one treatment apparatus configured to treat a container, and
an operation assistance system comprising:
a position detecting apparatus configured to detect a position and an orientation of a user in the container treatment plant, wherein the position detecting apparatus is configured, based on the position and the orientation of the user, to recognize the at least one treatment apparatus in the container treatment plant that is operated by the user;
an operation detecting apparatus configured to detect an operating state of the recognized at least one treatment apparatus; and
a mobile operation assistance apparatus configured to assist the user when operating the at least one treatment apparatus using operating recommendations based on the operating state of the recognized at least one treatment apparatus.

15. A method for assisting a user of a container treatment plant, the method comprising:
detecting, using a position detecting apparatus, a position and an orientation of the user in the container treatment plant, wherein, based on the position and the orientation of the user, a treatment apparatus in the container treatment plant that is operated by the user is recognized;
detecting, using the operation detecting apparatus, an operating state of the recognized treatment apparatus; and
assisting, using a mobile operation assistance apparatus, the user when operating the recognized treatment apparatus using operating recommendations based on the operating state of the recognized treatment apparatus.

16. The method of claim 15, further comprising exchanging, using at least one data transmitter, state information between the position detecting apparatus, the operation detecting apparatus, the mobile operation assistance apparatus, and a control station of the container treatment plant, wherein the control station is an external server or a cloud system.

17. The method of claim 16, further comprising simulating, using a state simulation apparatus, a digital image of the operating state of each treatment apparatus of a plurality of treatment apparatuses of the container treatment plant while in operation, based on environmental boundary conditions, to simulate operating scenarios and, based on results thereof, to transmit the operating recommendations to the mobile operation assistance apparatus using the data transmitter.

18. The method of claim 17, further comprising:
recording and storing, using the position detecting apparatus, paths of the user and the state information and the environmental boundary conditions of an operating environment; and
recording and storing, using the operation detecting apparatus, the environmental boundary conditions and the operating state of the treatment apparatus arranged in a path of the user.

19. The method of claim 17, wherein:
the operating recommendations are provided to the user by the mobile operation assistance apparatus and are at least one of:
parameter setting specifications for manipulated variables of the treatment apparatus;
virtually displaying the treatment apparatus being operated, preferably operated by a tool;
measures for correcting errors in the treatment apparatus; or
proposals for optimizing an arrangement of the treatment apparatus in the container treatment plant.

20. The method of claim 17, further comprising displaying, using a display apparatus, a direction of a shortest path to a further treatment apparatus by an arrow projected on the ground by the mobile operation assistance apparatus, wherein the further treatment apparatus is a treatment apparatus on which an operating recommendation is to be carried out.
